(19) United States
(12) Patent Application Publication
(10) Pub. No.: US 2026/0277303 A1
(43) Pub. Date: Sep. 17, 2026

(54) INFORMATION PROCESSING APPARATUS, INFORMATION PROCESSING METHOD, AND PROGRAM

(71) Applicant: SONY GROUP CORPORATION, TOKYO (JP)

(72) Inventors: TAKAYOSHI SHIMIZU, TOKYO (JP); YASUYUKI SUKI, TOKYO (JP); RYOSUKE NAKAYAMA, TOKYO (JP); TOMOHIRO ISHII, TOKYO (JP); SATOSHI ASAI, TOKYO (JP)

(21) Appl. No.: 19/167,120

(22) PCT Filed: Mar. 5, 2024
(86) PCT No.: PCT/JP2024/008215

§ 371 Date: Sep. 19, 2025

(30) Foreign Application Priority Data
Mar. 28, 2023 (JP) 2023-052106

(51) Int. Cl. G06F 3/01; G06T 19/20

(52) U.S. Cl. CPC G06F 3/011; G06T 19/20; G06T 2219/2021

(57) ABSTRACT

The present technology relates to an information processing apparatus, an information processing method, and a program adapted to provide content more advantageously. An information processing apparatus according to the present technology includes a detection part configured to detect a trigger and a video control part configured to cause, upon occurrence of the trigger, a virtual object to be displayed on a wearable device displaying a video of a real space corresponding to a field of view of a user. The present technology may be applied to a head-mounted display, for example.

### TECHNICAL FIELD

The present technology relates to an information processing apparatus, an information processing method, and a program. More particularly, the technology relates to an information processing apparatus, an information processing method, and a program adapted to provide content more advantageously.

### BACKGROUND ART

There exist VR (Virtual Reality) technologies that present videos of a virtual space to users and AR (Augmented Reality) technologies that present additional information displayed superimposed onto a real space to users. For example, PTL 1 describes a technology that provides display control on a virtual object linked to a real object in a real space.

There has been widespread use of HMDs (Head-Mounted Displays) and like devices serving as display apparatuses that utilize VR technologies and AR technologies.

### CITATION LIST

### Patent Literature

### [PTL 1]

PCT Patent Publication No. WO2017/098822

### SUMMARY

### Technical Problem

Experiencing the content provided by use of VR technologies and AR technologies requires a strong motivation and psychological preparation for immersion in, for example, a world view different from reality. In the technology described in PTL 1, for example, content may be displayed before the psychological preparation of the user is complete, which can detract from a sense of immersion. Further, removing the HMD after the experience can give the user a sense of emptiness caused by the difference between a virtual space and a real space.

The present technology has been devised in view of the above circumstances and aims to offer content in a more advantageous manner.

### Solution to Problem

According to one aspect of the present technology, there is provided an information processing apparatus including a detection part configured to detect a trigger and a video control part configured to cause, upon occurrence of the trigger, a virtual object to be displayed on a wearable device displaying a video of a real space corresponding to a field of view of a user.

According to another aspect of the present technology, there is provided an information processing method including, by an information processing apparatus, detecting a trigger and, upon occurrence of the trigger, causing a virtual object to be displayed on a wearable device displaying a video of a real space corresponding to a field of view of a user.

According to a further aspect of the present technology, there is provided a program for causing a computer to execute processing of detecting a trigger and, upon occurrence of the trigger, causing a virtual object to be displayed on a wearable device displaying a video of a real space corresponding to a field of view of a user.

According to an aspect of the present technology, a trigger is detected. Upon occurrence of the trigger, a virtual object is displayed on a wearable device displaying a video of a real space corresponding to a field of view of a user.

### BRIEF DESCRIPTION OF DRAWINGS

FIG. 1 is a view depicting an example of a situation where an HMD to which the present technology is applied is in use.

FIG. 2 is a view depicting examples of user's actions and states used as triggers.

FIG. 3 is a view depicting examples of methods for displaying virtual objects.

FIG. 4 is a first view depicting an example of the flow of experiencing outdoor content.

FIG. 5 is a view depicting an example of a trigger that starts providing the outdoor content.

FIG. 6 is a view depicting a first example of a virtual object displayed at a given timing in the outdoor content.

FIG. 7 is a view depicting an example of a visual effect of straddling a real space and a virtual space in the outdoor content.

FIG. 8 is a view depicting a second example of a virtual object displayed at a given timing in the outdoor content.

FIG. 9 is a view depicting another example of the flow of experiencing the outdoor content.

FIG. 10 is a view depicting an example of a transition to a video of a virtual space.

FIG. 11 is a view depicting an example of a video of a virtual space displayed at a given timing.

FIG. 12 is a view depicting an example of display following a transition to a video of a real space.

FIG. 13 is a first view depicting an example of the flow of experiencing content of a live music concert.

FIG. 14 is a view depicting a trigger that starts providing the content of the live music concert.

FIG. 15 is a view depicting a first example of a virtual object displayed at a given timing in the content of the live music concert.

FIG. 16 is a view depicting a second example of a virtual object displayed at a given timing in the content of the live music concert.

FIG. 17 is a view depicting a third example of a virtual object displayed at a given timing in the content of the live music concert.

FIG. 18 is a view depicting an example of a visual effect of straddling a real space and a virtual space in the content of the live music concert.

FIG. 19 is a second view depicting an example of the flow of experiencing the content of the live music concert.

FIG. 20 is a view depicting another example of display following a transition to a video of a real space.

FIG. 21 is a first view explaining an example of the flow of experiencing sports content.

FIG. 22 is a second view explaining an example of the flow of experiencing the sports content.

FIG. 23 is a third view explaining an example of the flow of experiencing the sports content.

FIG. 24 is a block diagram depicting an example of a configuration of the HMD.

FIG. 25 is a block diagram depicting an example of a functional configuration of an information processing part.

FIG. 26 is a flowchart explaining processing performed by the HMD.

FIG. 27 is a first view depicting an example of the flow of a transition to a video of a virtual space in the sports content.

FIG. 28 is a second view depicting an example of the flow of a transition to a video of a virtual space in the sports content.

FIG. 29 is a block diagram depicting an example of a hardware configuration of a computer.

### DESCRIPTION OF EMBODIMENTS

Some embodiments for implementing the present technology are described below. The description will be made in the following order.
1. Overview of Present Technology
2. Configuration and operation of HMD
3. Modifications

### 1. Overview of Present Technology

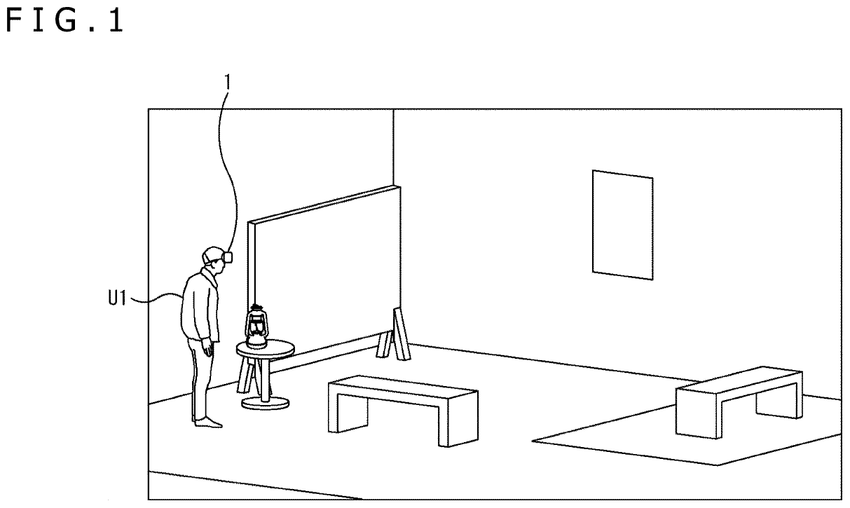

FIG. 1 is a view depicting an example of a situation where an HMD to which the present technology is applied is in use.

As depicted in FIG. 1, a user U1 wears an HMD 1 on the head in a real space such as a user's own room.

The HMD 1 is configured as a display apparatus which has a VST (Video See Through) function, for example, and includes a camera and a non-transmissive display unit. Wearing the HMD 1 causes the field of view to be blocked by the display unit and a housing, so that the user U1 is unable to directly view what the outside world (real space) is like. However, an outside world image captured by the camera appears on the display, allowing the user U1 to view the state of the outside world while wearing the HMD 1.

The viewing angle (imaging range) of the camera on the HMD 1 corresponds to the field of view (visible range) of the user U1 not wearing the HMD 1. The viewing angle moves when the user U1 changes the head direction, for example.

The display unit of the HMD 1 displays a virtual object superimposed on a video of a real space, or displays a video of a virtual space. Viewing the video displayed on the display unit of the HMD 1 allows the user U1 to experience AR or VR content.

Experiencing the AR or VR content requires a strong motivation and psychological preparation for immersion in a world view different from reality, for example. Conventionally, content may be displayed before the psychological preparation of the user is complete, which can detract from a user's sense of immersion. Also, removing the HMD after the experience can give the user a sense of emptiness because of the difference between a virtual space and a real space.

The HMD 1 according to the present technology detects the user's action or state as a trigger. Upon occurrence of the trigger, content is provided in such a manner that a virtual object is displayed on the display unit displaying a video of a real space corresponding to the user's field of view so as not to detract from the sense of immersion or give the user a sense of emptiness.

Specifically, every time a trigger occurs, the HMD 1 gradually displays a plurality of virtual objects, starting with the virtual object that symbolizes the content. This causes the video displayed on the display unit to transition from a video of a real space to a video of a virtual space. Each virtual object is displayed in a manner appearing gradually, for example.

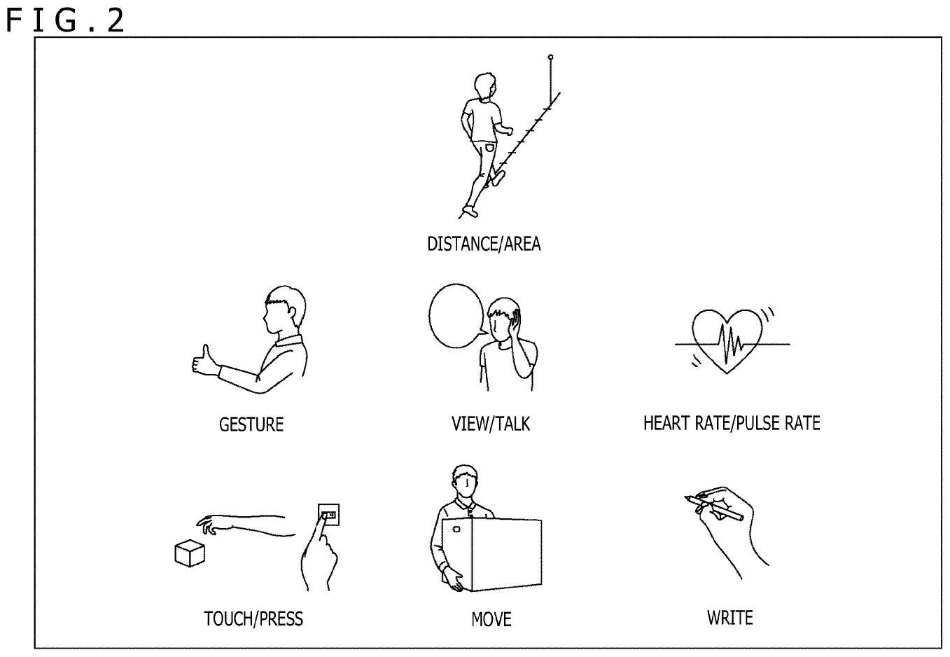

FIG. 2 is a view depicting examples of user's actions and states used as triggers.

As depicted in FIG. 2, triggers may be, for example, the distance between the user and an object (a real object or a virtual object), an area where the user is located, a gesture made by the user, the user viewing an object, the user talking to an object, and the heart rate or pulse rate of the user. Further, triggers may be, for example, the user touching an object, pressing a switch (a real object or a virtual object), moving an object, or writing a predetermined letter. Alternatively, the operations using a device such as a controller may be also used as triggers.

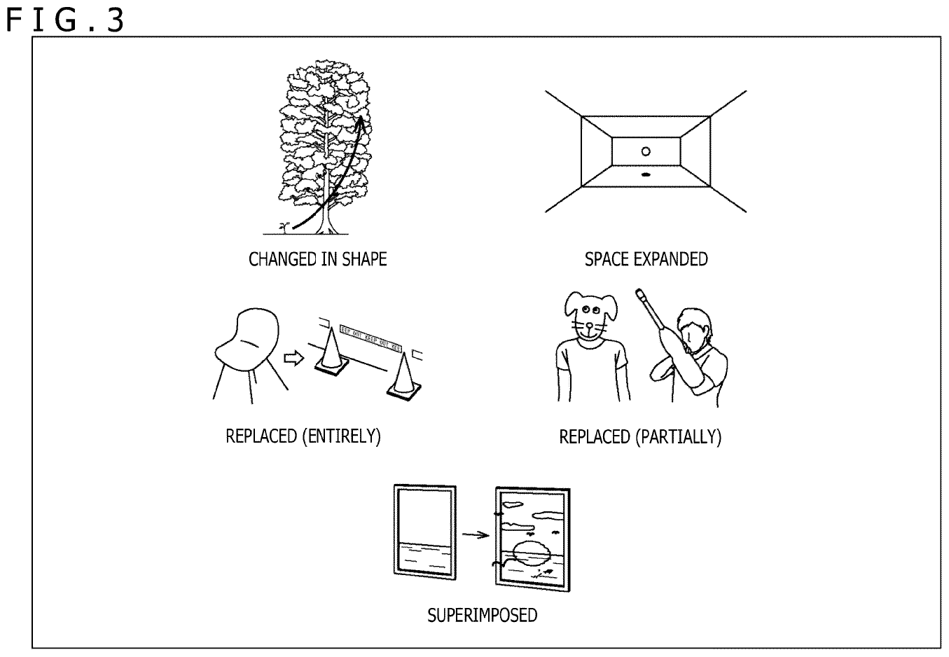

FIG. 3 is a view depicting examples of methods for displaying virtual objects.

As depicted in FIG. 3, a virtual object is displayed in such a manner as to be changed in shape, for example, and thus appear gradually. Also, for example, the virtual object is displayed in a real space being expanded, or displayed in a manner replacing the entire real object, replacing partially a real object or the user's body, or being superimposed on a real object.

### Example of Outdoor Content

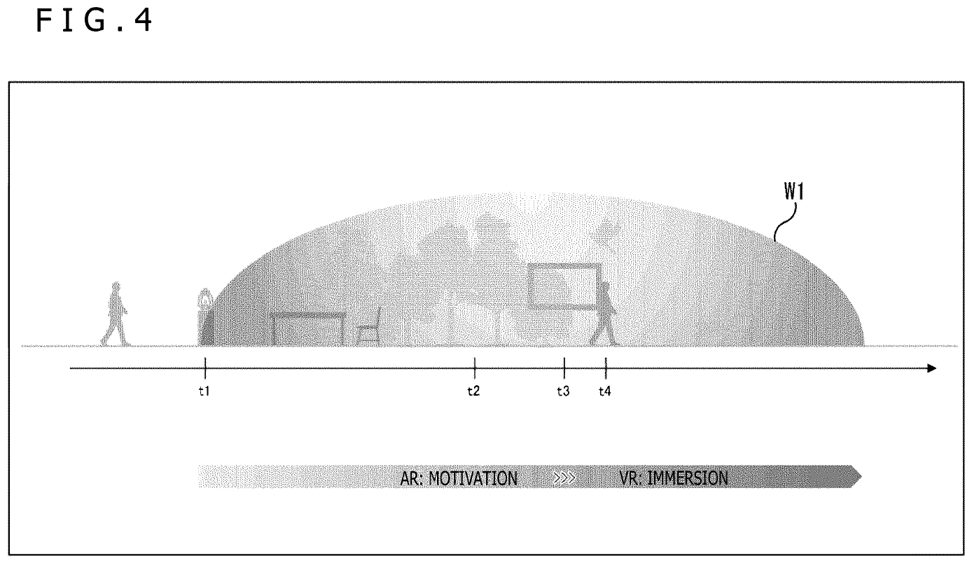

An example of the flow of experiencing outdoor content is explained below with reference to FIGS. 4 through 12.

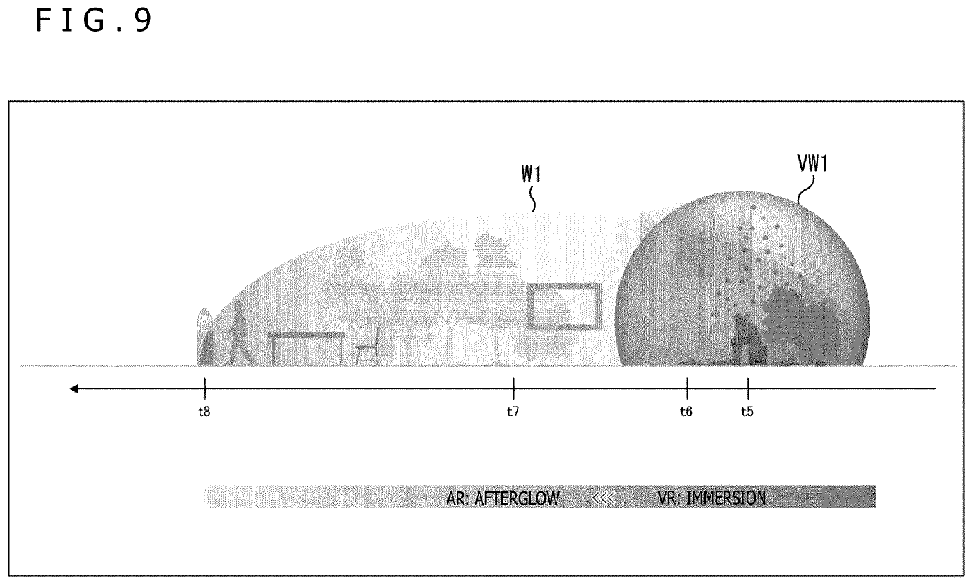

FIGS. 4 and 9 are views depicting examples of the flow of experiencing outdoor content.

First, at timing t1 in FIG. 4, the outdoor content starts to be provided.

The user can experience the outdoor content in an AR space W1, which is a mixture of a real space and a virtual space.

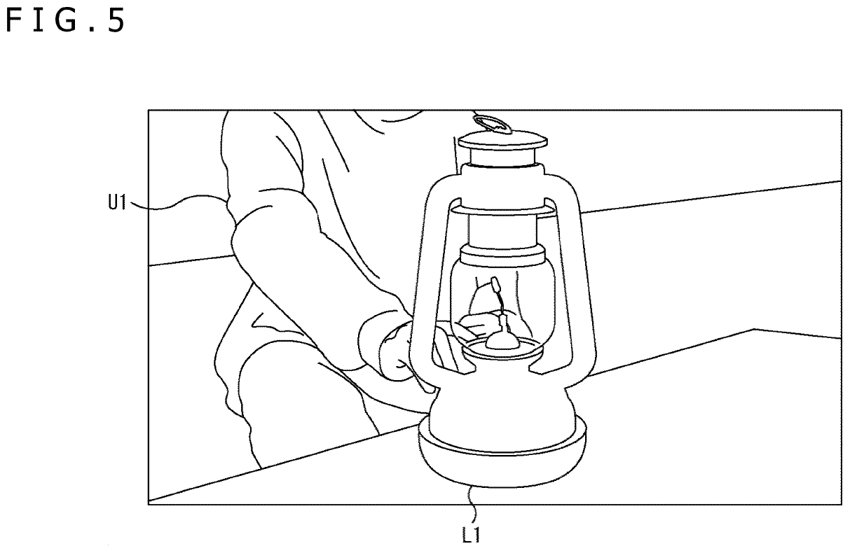

FIG. 5 is a view depicting an example of a trigger that starts providing the outdoor content.

As depicted in FIG. 5, the outdoor content starts to be provided when the user U1 turns on a switch of a lantern L1 (presses an object), which is a trigger. After the user U1 touches a real object, the HMD 1 starts providing the content, allowing the user U1 to intuitively understand the beginning of the experience.

When the content starts to be provided, a virtual object is gradually displayed at timing t2 in FIG. 4, for example.

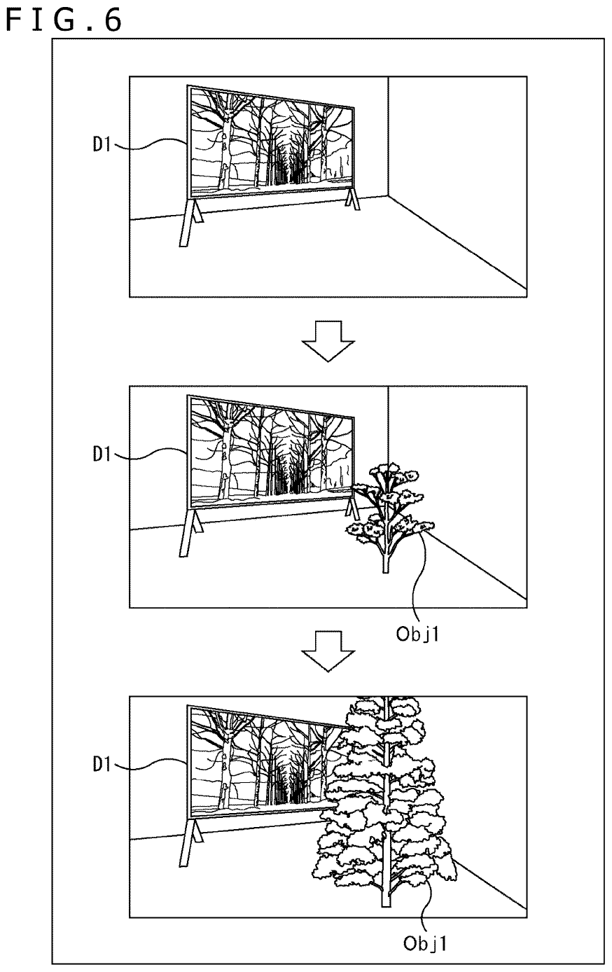

FIG. 6 is a view depicting an example of a virtual object displayed at timing t2.

Before the content starts to be provided, a video of a real space is displayed as indicated in the upper part of FIG. 6. In the example in the upper part of FIG. 6, a video of a room in which a display device D1 is installed against a wall is partially displayed.

When the content starts to be provided, as indicated in the middle part and the lower part of FIG. 6, a virtual object Obj1 of a tree is displayed sprouting out of the floor of the room and gradually growing (the virtual object is changed in shape), for example.

The HMD 1 senses the three-dimensional positions of real objects, walls, floors, etc., placed in the room, by using recognition technologies such as semantic segmentation and instance segmentation. The HMD 1 places the tree virtual object Obj1 in keeping with the positions of the sensed real objects and the configuration of the room. For example, the tree virtual object Obj1 is placed in a corner of the room that does not overlap with the wall or with the display device D1.

Next, at timing t3 in FIG. 4, a visual effect is used to straddle the real space and the virtual space.

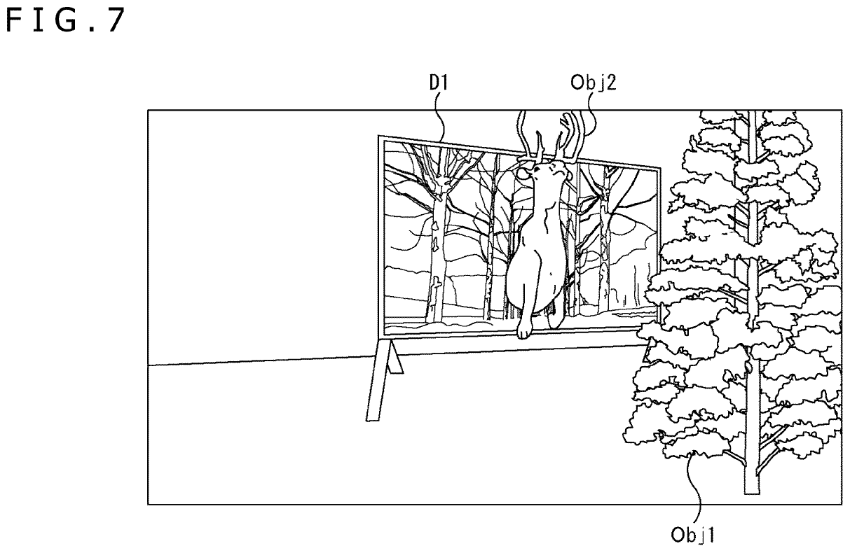

FIG. 7 is a view depicting an example of the visual effect of straddling the real space and the virtual space.

As depicted in FIG. 7, a virtual object Obj2 of a reindeer is displayed as if jumping out of a screen of the display device D1 (superimposition of virtual objects), for example. The sudden appearance of an extraordinary element in an everyday real space creates a gap with reality, producing the effect that stays in the memory of the user U1.

When the distance between the user U1 and the display device D1 becomes equal to or less than a predetermined threshold, it may trigger the display of the reindeer virtual object Obj2. Alternatively, after a predetermined time has elapsed from the display of the tree virtual object Obj1, it may trigger the display of the reindeer virtual object Obj2.

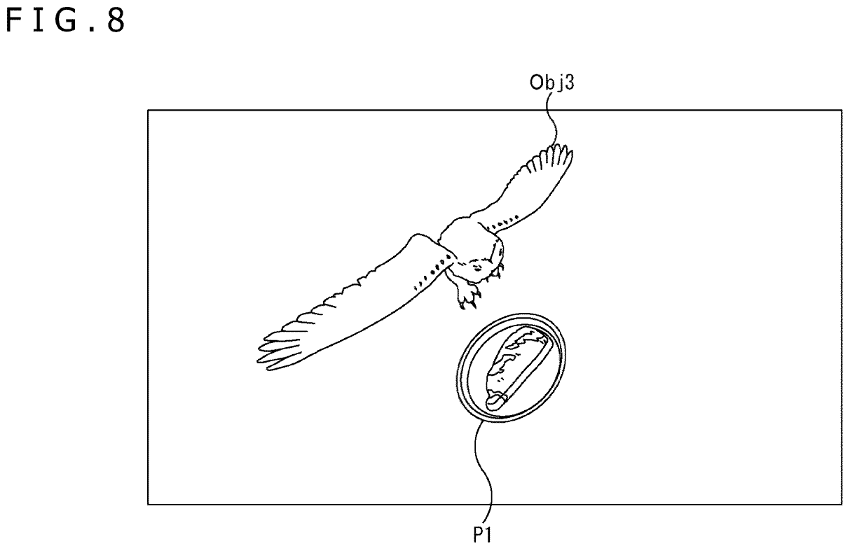

Next, at timing t4 in FIG. 4, as depicted in FIG. 8, the user U1 moves a plate (feed plate) P1 carrying a meat sample, which triggers a virtual object Obj3 of an owl to be displayed chasing the plate P1.

The HMD 1 senses the position of the plate P1 in real time, so that the actions of the user U1 relative to the plate P1 can be reflected in the presentation in the AR space W1. This makes it possible to realize operations using real objects other than devices such as the controller.

Next, at timing t5 in FIG. 9, a transition is made from the video of the real space (AR space W1) to a video of a virtual space VW1.

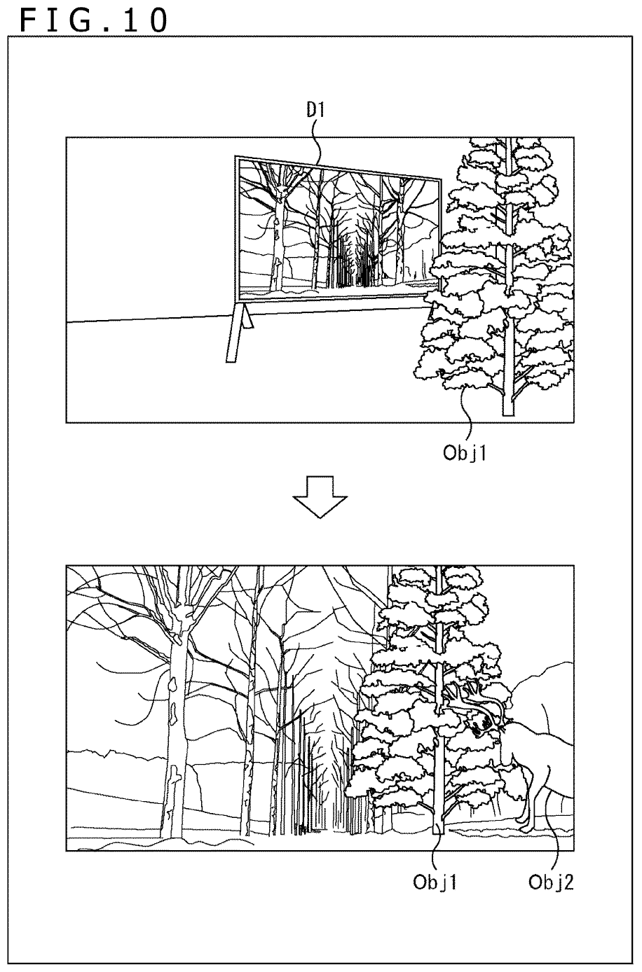

FIG. 10 is a view depicting an example of a transition to the video of the virtual space VW1.

As depicted in the upper part of FIG. 10, while the video of the AR space W1 is being displayed, the user U1 sitting down on a bench which is a real object, for example, triggers a fade-in of the video of the virtual space VW1 representing a forest, for example, as depicted in the lower part of FIG. 10. The act of the user U1 sitting down on the bench is recognized on the basis of the distance between the user U1 and the bench, for example.

The virtual objects that have been displayed up to timing t5 are placed in the virtual space VW1. In the example in FIG. 10, the tree virtual object Obj1 and the reindeer virtual object Obj2 are included in the video of the virtual space VW1. In such a manner, the HMD 1 implements a seamless transition from the video of the real space to the video of the virtual space VW1 by displaying at least one of the plurality of virtual objects in the virtual space VW1 superimposed on the video of the real space before displaying the video of the virtual space VW1.

Natural actions such as approaching or moving away from an object are linked to the transition from the video of the real space to the video of the virtual space. This allows the user U1 to switch modes without having to perform such operations as switching from a mode for displaying real-space videos to a mode for displaying virtual-space videos.

If the user U1 moves while the video of the virtual space VW1 is being displayed, there is a possibility that the user U1 may bump into a real object in the room. By displaying the video of the real space when the user U1 is likely to move and displaying the video of the virtual space VW1 when the user U1 is not likely to move such as when the user U1 is sitting down on a bench, the risk of the user U1 bumping into a real object can be reduced. Moreover, the HMD 1 can provide a highly immersive experience by increasing the motivation for the experience through phased display of virtual objects before displaying the video of the virtual space VW1.

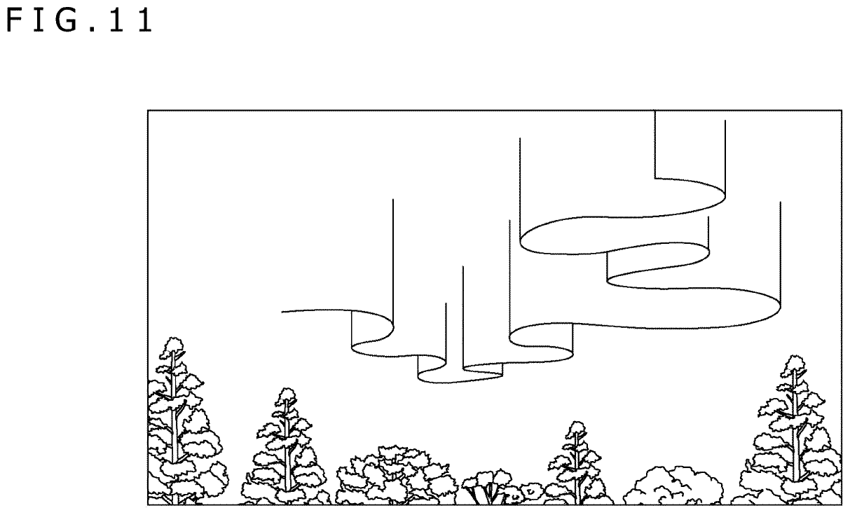

After the transition to the video of the virtual space VW1 is complete, if the user U1 looks up at timing t6 in FIG. 9, for example, a sky with an aurora is displayed as depicted in FIG. 11.

Next, at timing t7 in FIG. 9, a transition is made from the video of the virtual space VW1 to the video of the real space (AR space W1). The transition to the video of the real space (AR space W1) is triggered by the user U1 standing up from the bench, for example. The act of the user U1 standing up from the bench is recognized on the basis of the distance between the user U1 and the bench, for example.

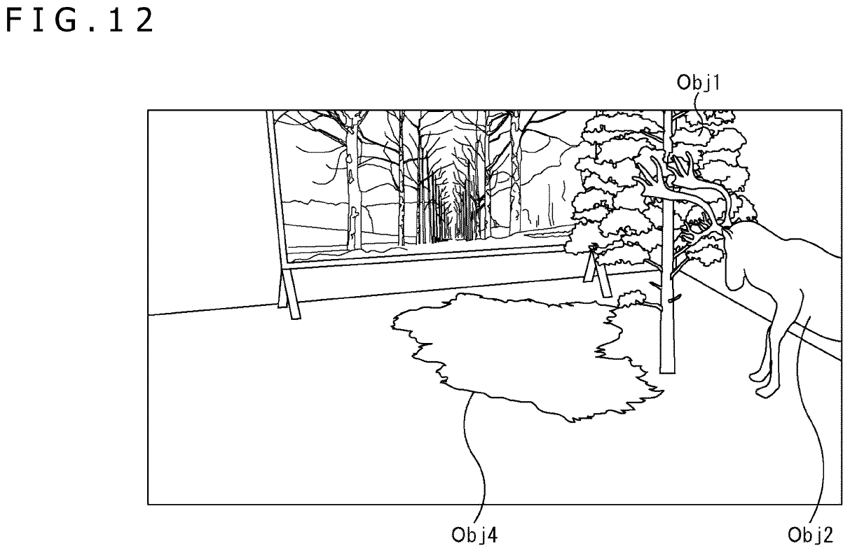

FIG. 12 is a view depicting an example of display following a transition to the video of the real space.

When the user U1 stands up from the bench, for example, some of the virtual objects placed in the virtual space VW1 are displayed superimposed on the video of the real space as depicted in FIG. 12. In the example in FIG. 12, the tree virtual object Obj1, the reindeer virtual object Obj2, and a virtual object Obj4 of snow are displayed.

In such a manner, even after the display of the video of the virtual space VW1 has ended, the HMD 1 displays at least one of the plurality of virtual objects placed in the virtual space VW1 superimposed on the video of the real space, thereby not separating the experience in the virtual space VW1 from the experience in the AR space W1. While viewing some of the virtual objects placed in the virtual space VW1, the user U1 can look back on the experience in the virtual space VW1 and feel the afterglow of the experience in the virtual space VW1.

Finally, at timing t8 in FIG. 9, the outdoor content stops being provided. For example, the end of the outdoor content being provided is triggered by the user U1 turning off the switch of the lantern L1 (pressing an object), for example. By ending the provision of the content after allowing the user U1 to feel the afterglow of the virtual space VW1, it is possible to make the user U1 less likely to feel a sense of emptiness caused by the difference between the virtual space VW1 and the real space when the HMD 1 is removed.

### Example of Content of Live Music Concert

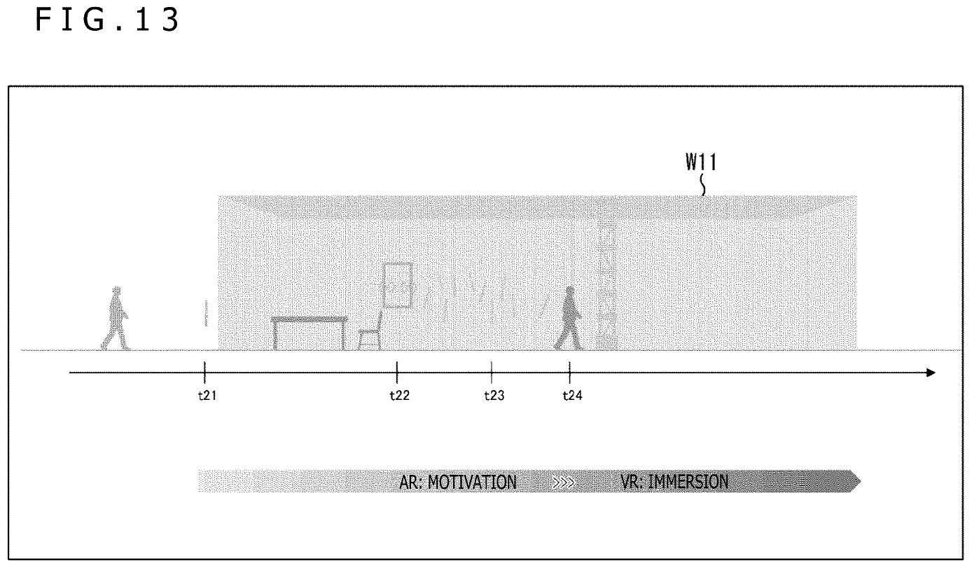

An example of the flow of experiencing content of a live music concert is explained below with reference to FIGS. 13 through 20.

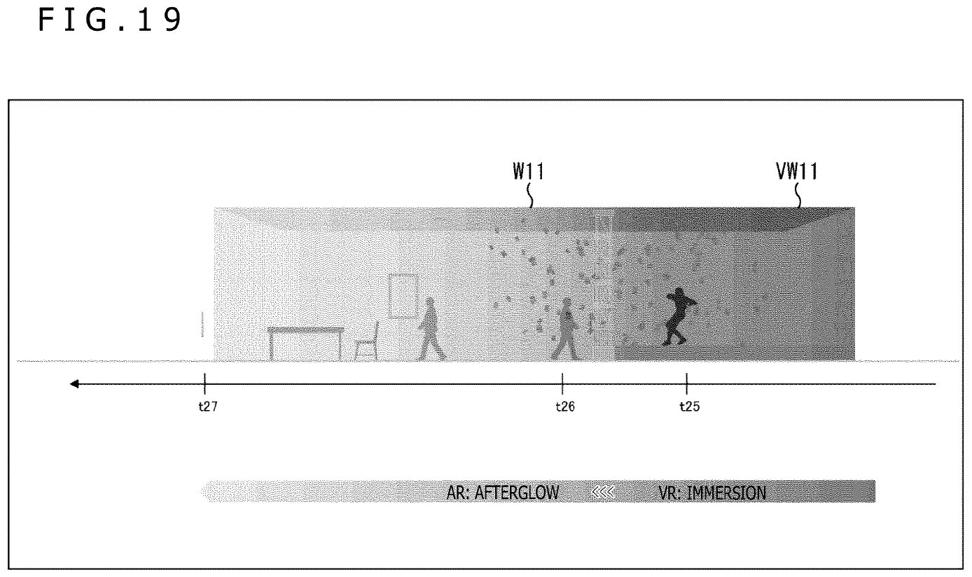

FIGS. 13 and 19 are views depicting an example of the flow of experiencing content of a live music concert.

First, at timing t21 in FIG. 13, the content of the live music concert starts to be provided. A user can experience the content of the live music concert in an AR space W11, which is a mixture of a real space and a virtual space.

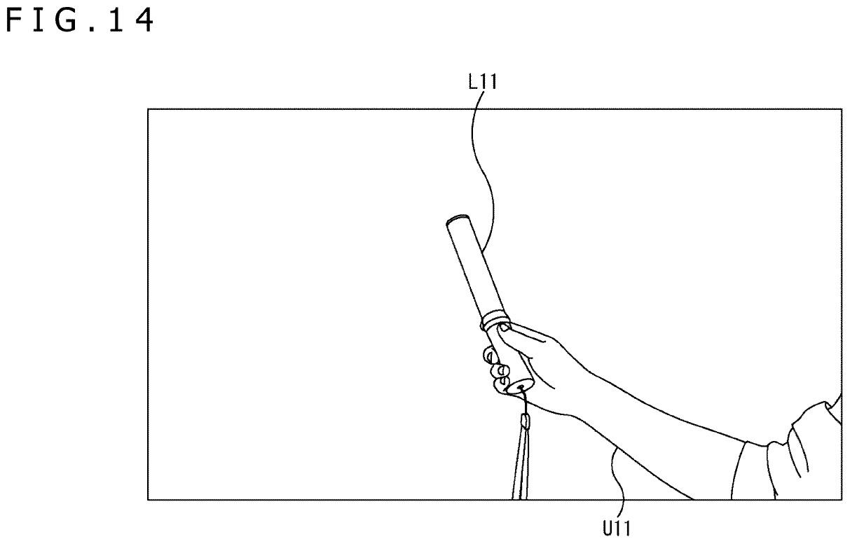

FIG. 14 is a view depicting a trigger that starts providing the content of the live music concert.

As depicted in FIG. 14, the content of the live music concert starts to be provided when a user U11 turns on a switch of a penlight L11 (presses an object), which is a trigger. After the user U11 has touched the real object, the HMD 1 starts providing the content. This allows the user U11 to intuitively understand the beginning of the experience.

When the content starts to be provided, a virtual object, for example, is displayed superimposed on a video of the real space at timing t22 in FIG. 13.

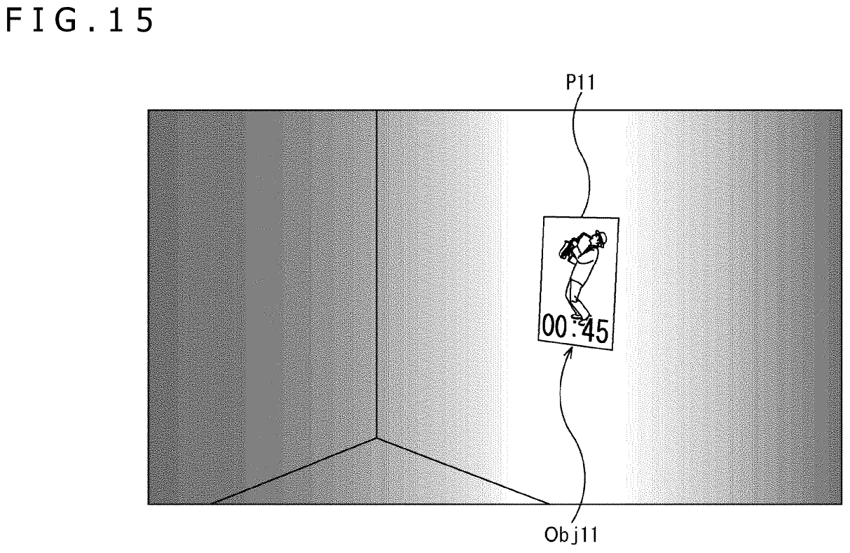

FIG. 15 is a view depicting an example of a virtual object displayed at timing t22.

For example, as depicted in FIG. 15, a virtual object Obj11 of a countdown timer indicating the time up to the start of a live music concert is displayed on a poster P11 attached to a wall. The video of the real space near the countdown timer virtual object Obj11 is displayed bright, and the video of the real space outside of it is displayed dark.

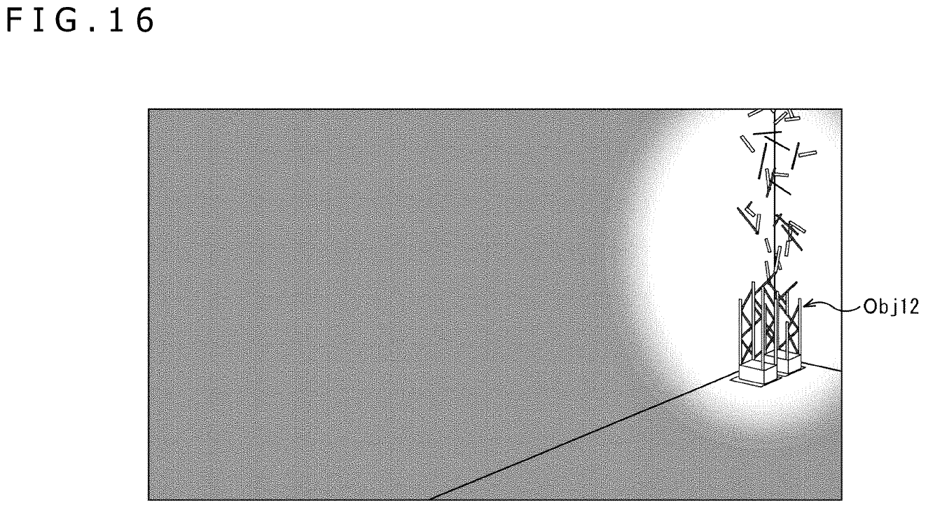

FIG. 16 is a view depicting another example of a virtual object displayed at timing t22.

For example, as depicted in FIG. 16, a virtual object Obj12 of equipment for a live performance venue is displayed in a manner being gradually assembled. The video of the real space near the equipment virtual object Obj12 is displayed bright, and the video of the real space outside of it is displayed dark.

The HMD 1 senses the three-dimensional positions of real objects, walls, floors, etc., installed in a room, and places the countdown timer virtual object Obj11 and the equipment virtual object Obj12 in keeping with the sensed positions of the real objects and the configuration of the room.

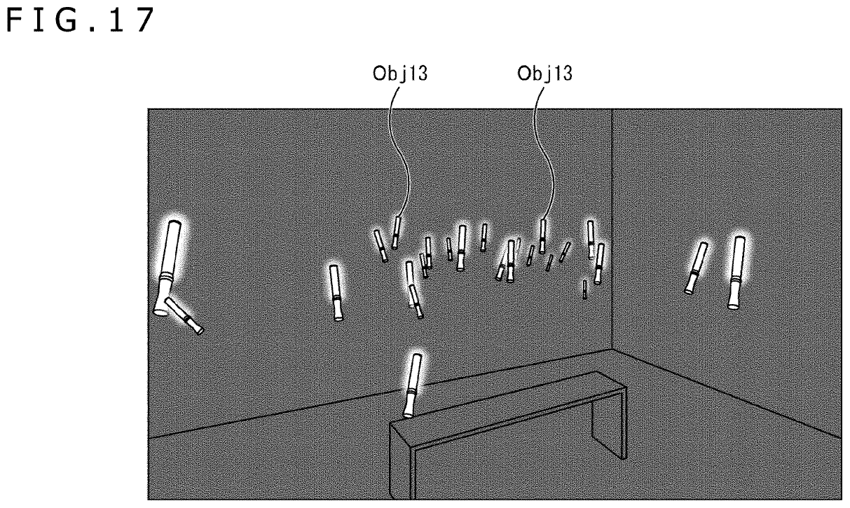

Next, at timing t23 in FIG. 13, the user U11 approaches the equipment virtual object Obj12 (or the wall), which triggers the display of virtual objects Obj13 of a plurality of glowing penlights floating in the air as depicted in FIG. 17. Viewing the penlight virtual objects Obj13, the user U11 can get the feeling of taking part in the live music concert in the presence of a large audience.

The number of penlight virtual objects Obj13 changes depending on the distance between the user U11 and the equipment virtual object Obj12 (or the wall), for example. This can provide a representation in which the closer the user U11 gets to the equipment virtual object Obj12, the more spectators gather. Further, the brightness of the video of the real space may be varied depending on the distance between the user U11 and the equipment virtual object Obj12 (or the wall).

Next, at timing t24 in FIG. 13, a visual effect is used to straddle the real space and the virtual space.

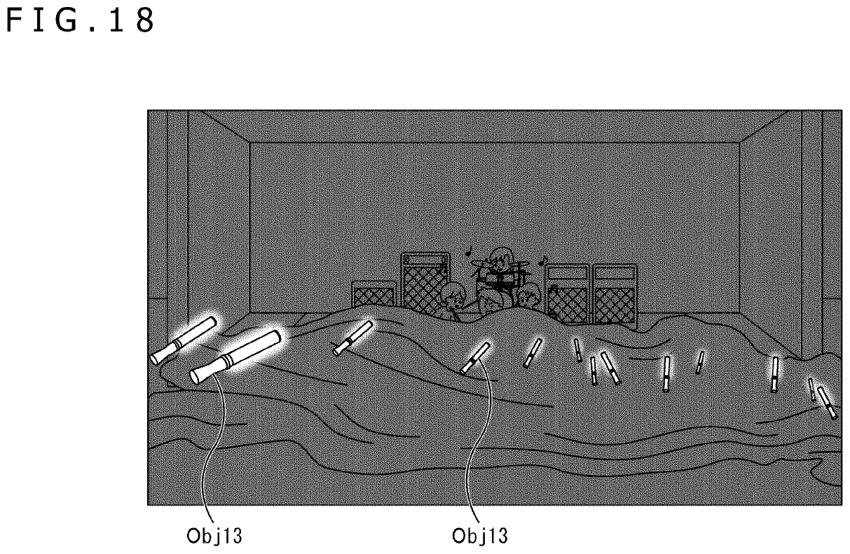

FIG. 18 is a view depicting an example of the visual effect of straddling the real space and the virtual space.

As depicted in FIG. 18, the visual effect is used such that a real object wall is displayed like a dropping curtain, revealing a stage of the live performance venue behind the wall (extension of the real space). The sudden appearance of an extraordinary element in an everyday real space creates a gap with reality, producing the effect that stays in the memory of the user U11.

When the distance between the user U11 and the equipment virtual object Obj12 becomes equal to or less than a predetermined threshold, it may trigger the display of the stage. Alternatively, when the time indicated by the countdown timer virtual object Obj11 reaches zero, it may trigger the display of the stage.

For example, at the time when the stage is displayed, a transition is made from the video of the real space (AR space W11) to the video of a virtual space VW11 representing the live concert venue. At timing t25 in FIG. 19, the user U11 can experience the live music concert taking place in the virtual space VW11.

In the virtual space VW11, virtual objects such as the equipment virtual object Obj12, the penlight virtual objects Obj13, and the stage displayed up until timing t25 are placed. In such a manner, before displaying the video of the virtual space VW11, the HMD 1 displays at least one of the plurality of virtual objects placed in the virtual space VW11 superimposed on the video of the real space. This provides a seamless transition from the video of the real space to the video of the virtual space VW11.

It is to be noted that, after the live music concert has started, a visual effect may be used to straddle the real space and the virtual space VW11, thereby making a transition from the video of the real space (AR space W11) to the video of the virtual space VW11.

Further, in a case where the distance between the user U11 and the stage (wall) becomes equal to or greater than a predetermined threshold, a transition may be made from the video of the virtual space VW11 to the video of the real space (AR space W11). In such a manner, natural actions such as approaching or moving away from an object are linked to the transition from the video of the real space to the video of the virtual space (or from the video of the virtual space to the video of the real space). The user U11 can thus switch modes without performing such operations as switching from a mode for displaying real-space videos to a mode for displaying virtual-space videos.

Next, at timing t26 in FIG. 19, a transition is made from the video of the virtual space VW11 to the video of the real space (AR space W11). For example, the end of the live music concert is used as a trigger to display the video of the real space (AR space W11).

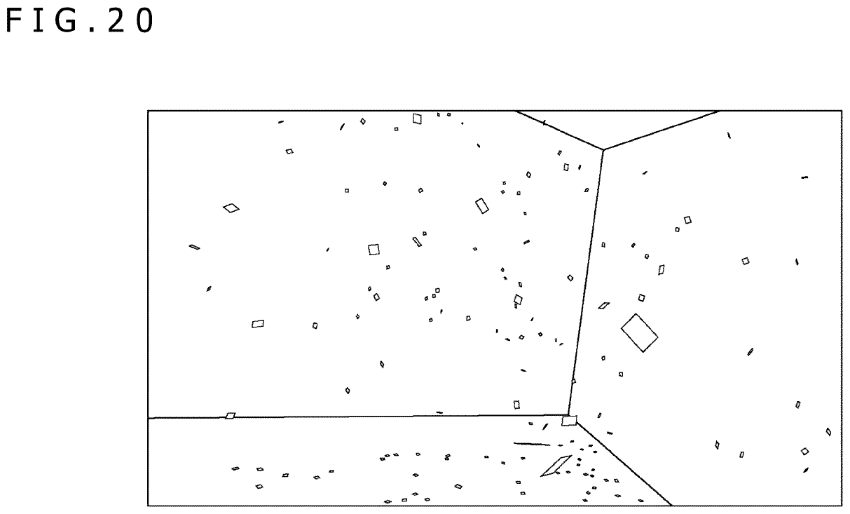

FIG. 20 is a view depicting an example of display following a transition to the video of the real space.

When the live music concert ends, as depicted in FIG. 20, some of the virtual objects in the virtual space VW11 are displayed superimposed on the video of the real space, or some of the real objects are displayed replaced with the corresponding virtual objects. In the example in FIG. 20, virtual objects of tapes used as effects toward the end of the live music concert are displayed.

In such a manner, even after the display of the video of the virtual space VW11 has ended, the HMD 1 displays at least one of the plurality of virtual objects placed in the virtual space VW11 superimposed on the video of the real space, thereby not separating the experience in the virtual space VW11 from the experience in the AR space W11. While viewing some of the virtual objects placed in the virtual space VW11, the user U11 can look back on the experience in the virtual space VW11 and feel the afterglow of the experience in the virtual space VW11.

Finally, at timing t27 in FIG. 19, the content of the live music concert stops being provided. For example, the end of the content of the live music concert being provided is triggered by the user U11 turning off the switch of the penlight L11 (pressing an object), for example. By ending the provision of the content after allowing the user U11 to feel the afterglow of the experience in the virtual space VW11, it is possible to make the user U11 less likely to feel a sense of emptiness caused by the difference between the virtual space VW11 and the real space when the HMD 1 is removed.

### Example of Sports Content

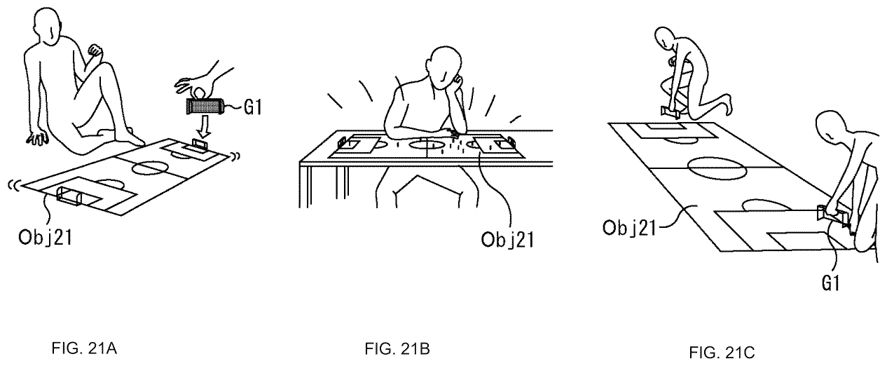

An example of the flow of experiencing sports content is explained below with reference to FIGS. 21 through 23.

As depicted in A of FIG. 21, when the user places a model G1 of a soccer goal, which is a real object, on the floor, a virtual object Obj21 of a soccer court is displayed in accordance with the position of the model G1, for example.

Also, as depicted in B of FIG. 21, when a user places the model of the soccer goal on a desk, the soccer court virtual object Obj21 is displayed in accordance with the position of the model, for example.

Further, as depicted in C of FIG. 21, when the user moves the model G1, the soccer court virtual object Obj21 is displayed increased or reduced in size in accordance with the position of the model G1.

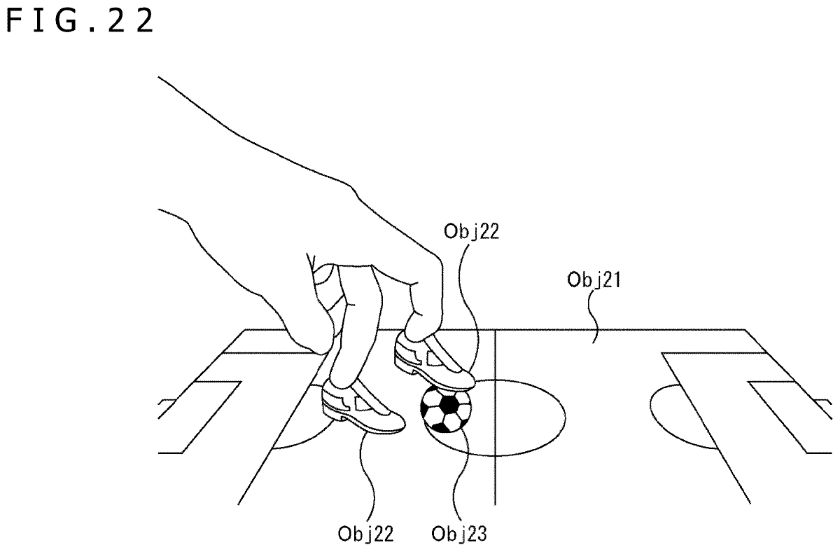

As depicted in FIG. 22, the tips of the user's index finger and middle finger are displayed replaced with virtual objects Obj22 of shoes. One of the shoe virtual objects Obj22 is displayed connected to a virtual object Obj23 of a soccer ball.

When the user places the shoe virtual object Obj22 or the soccer ball virtual object Obj23 in a desired position on the soccer court virtual object Obj21, it triggers a transition from a video of a real space to a video of a virtual space reproducing a stadium where a soccer match is being played. For example, the transition is made to the video of the virtual space by changing the area under the user's feet to a turf and by gradually changing the surroundings of the user to a stadium.

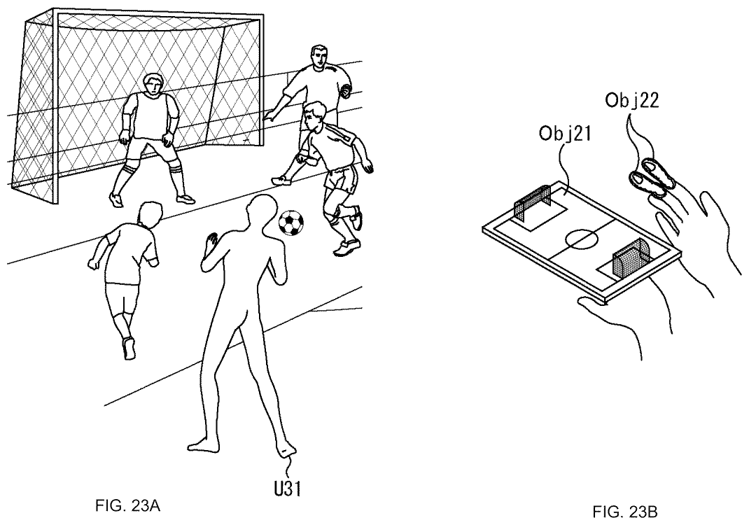

The video displayed on the HMD 1 is a video seen from the viewpoint corresponding to that position on the soccer court virtual object Obj 21 which is designated by placing the shoe virtual objects Obj22 there, for example. As depicted in A of FIG. 23, a user U31 can have the experience of standing on an actual soccer court and watching the match being played.

After the video of the virtual space is displayed, the soccer court virtual object Obj21 is displayed floating, for example, above the palm of the user's left hand as depicted in B of FIG. 23. When the left hand moves, the soccer court virtual object Obj21 moves in a manner tracking the left hand, for example.

Even after the video of the virtual space is displayed, the tips of the right hand's index finger and middle finger are displayed replaced with the shoe virtual objects Obj22. The user can change the viewpoint in the virtual space by placing the shoe virtual objects Obj21 in a desired position on the soccer court virtual object Obj21 displayed on the palm of the left hand. Also, when the user jumps or makes such an action as jumping with the right hand, a transition is made from the video of the virtual space to the video of the real space. When the transition to the video of the real space takes place, the user can look at the virtual object Obj21 and get a bird's-eye-view of the soccer court again as depicted in FIG. 21.

With the HMD 1 of the present technology, as described above, the user's actions or states are detected as triggers. In a case where such a trigger occurs, a virtual object is displayed on the display unit displaying the video of the real space corresponding to the user's field of view. The virtual object is displayed after the user performs a triggering action such as turning on a lantern and the user's psychological preparation is complete. This makes it possible to prevent the user's loss of the sense of immersion and provide the content more advantageously.

### 2. Configuration and Operation of HMD

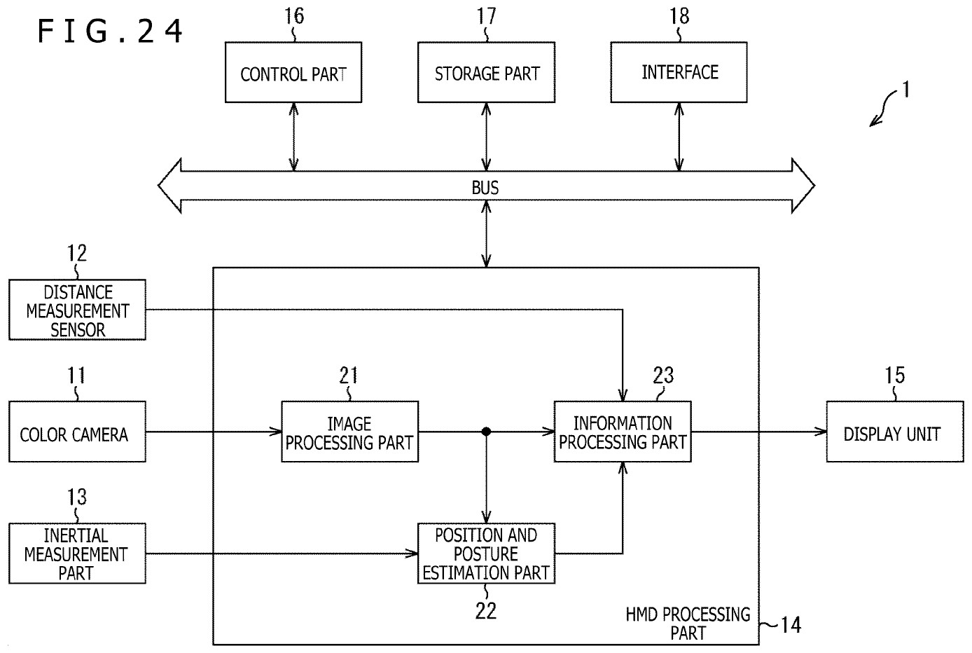

FIG. 24 is a block diagram depicting a configuration example of the HMD 1.

As depicted in FIG. 24, the HMD 1 includes a color camera 11, a distance measurement sensor 12, an inertial measurement part 13, an HMD processing part 14, a display unit 15, a control part 16, a storage part 17, and an interface 18.

The color camera 11 is equipped with an imaging element and a signal processing circuit, among others, and captures RGB or monochrome color videos. The color camera 11 includes a camera that captures a video on a left-eye display and a camera that captures a video on a right-eye display. The cameras are installed outside the housing of the HMD 1 in a manner facing the direction of the user's line of sight and capturing the outside world in the direction of the user's field of view.

The distance measurement sensor 12 is a sensor that measures the distance to a subject to thereby obtain depth information. The distance measurement sensor 12 is provided outside the housing of the HMD 1 in a manner facing the direction of the user's line of sight. The distance measurement sensor 12 may be an infrared sensor, an ultrasonic sensor, a color stereo camera, an IR (Infrared) stereo camera, or the like. The distance measurement sensor 12 may also acquire the depth information through triangulation using one IR camera and Structured Light. It is to be noted that the depth information need not be expressed in terms of stereo depth and may be given in terms of monocular depth using ToF (Time of Flight) or motion parallax, or in terms of monocular parallax using a video plane phase difference.

The inertial measurement part 13 includes various kinds of sensors that detect sensor information for estimating the posture, inclination, etc., of the HMD 1. The inertial measurement part 103 includes, for example, an IMU (Inertial Measurement Unit), an acceleration sensor for two or three axial directions, an angular velocity sensor, a gyro sensor, and the like.

The HMD processing part 14 has an image processing part 21, a position and posture estimation part 22, and an information processing part 23.

The image processing part 21 performs predetermined image processing such as A/D (Analog/Digital) conversion, white balance adjustment, color correction, gamma correction, Y/C conversion, and AE (Auto Exposure) processing on a video signal obtained from the color camera 11. It is to be noted that the image processing described above is only an example and need not be carried out entirely and that other processing may also be performed. The image processing part 21 supplies a video that has been subjected to the image processing to the position and posture estimation part 22 and the information processing part 23.

The position and posture estimation part 22 estimates the position and posture, for example, of the HMD 1 on the basis of the sensor information acquired from the inertial measurement part 13 and the video supplied from the image processing part 21. By estimating the position and posture of the HMD 1 with the position and posture estimation part 22, it is also possible to estimate the position and posture of the head of the user wearing the HMD 1. It is to be noted that the position and posture estimation part 22 can also estimate the motion and tilt, for example, of the HMD 1. The position and posture estimation part 22 supplies the estimation results of the position and posture, for example, of the HMD 1 to the information processing part 23.

The information processing part 23 combines the video supplied from the image processing part 21 with a CG (Computer Graphics) video, and supplies the composite video to the display unit 15 for display.

It is to be noted that the information processing part 23 may be configured as a stand-alone apparatus, may operate in the HMD 1, or may operate in an electronic device such as a personal computer, a tablet terminal, or a smartphone connected to the HMD 1. Further, a program may cause the HMD 1 or the electronic device to perform the function of the information processing part 23. In a case where the information processing part 23 is implemented by a program, the program may be preinstalled in the HMD 1 or in the electronic device, or may be distributed by download or on a storage medium or the like for installation by the user.

The display unit 15 is a liquid crystal display or an organic EL (Electro-Luminescence) display located in front of the user's eyes when the HMD 1 is worn. The display unit 15 includes a display for the left eye and a display for the right eye. The display unit 15 displays videos under control of the information processing part 23.

The control part 16 includes a CPU (Central Processing Unit), a RAM (Random Access Memory), and a ROM (Read Only Memory), for example. The CPU controls the entire HMD 1 and its components by executing various kinds of processes and by issuing commands in accordance with the programs stored in the ROM. It is to be noted that the information processing part 23 may be implemented through processing by the control part 16.

The storage part 17 includes a large-capacity storage medium such as a hard disk or a flash memory, for example. The storage part 17 stores various kinds of applications that run on the HMD 1, as well as various kinds of information used by the HMD 1 and the information processing part 23, for example.

The interface 18 interfaces with, for example, other electronic devices and the Internet. The interface 18 includes wired or wireless communication interfaces. The wired or wireless communication interfaces include cellular communication, Wi-Fi, Bluetooth (registered trademark), NFC (Near Field Communication), Ethernet (registered trademark), an HDMI (registered trademark) (High-Definition Multimedia Interface), and a USB (Universal Serial Bus), for example.

It is to be noted that the HMD processing part 14 may operate in the HMD 1 or in an electronic device such as a PC, a game machine, a tablet terminal, or a smartphone connected to the HMD 1. In a case where the HMD processing part 14 operates in the electronic device, the camera image captured by the color camera 11, the depth information acquired by the distance measurement sensor 12, and the sensor information obtained by the inertial measurement part 13 are transmitted to the electronic device via the interface 18. Further, output from the information processing part 23 is transmitted to the HMD 1 via the interface 18 and displayed on the display unit 15,

The HMD 1 may be a wearable device such as glasses, or may be integrated with headphones or earphones (inner-ear headphones). The HMD 1 may also be a wearable device in which an electronic device such as a smartphone or a tablet terminal is fitted into a band-like attachment, rather than a device of which the display and the housing are integrated.

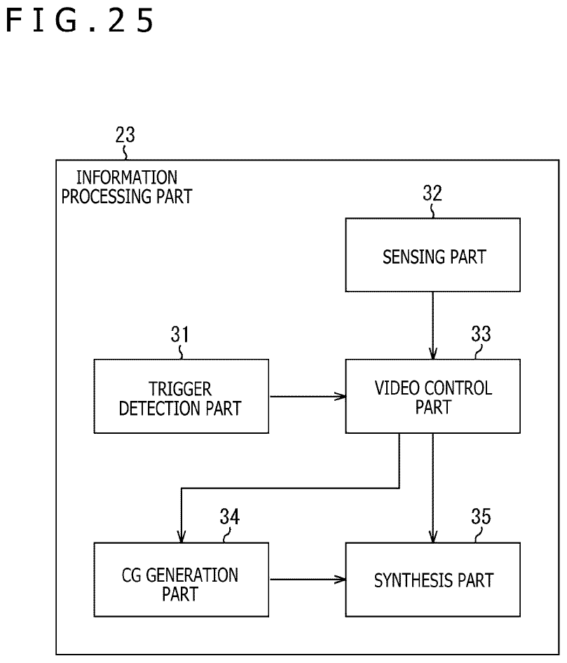

FIG. 25 is a block diagram depicting an example of a functional configuration of the information processing part 23.

As depicted in FIG. 25, the information processing part 23 includes a trigger detection part 31, a sensing part 32, a video control part 33, a CG generation part 34, and a synthesis part 35.

The trigger detection part 31 detects the user's action or state serving as a trigger to display a virtual object, on the basis of the depth information acquired from the distance measurement sensor 12 and the estimation results of the position and posture, for example, of the HMD 1 supplied from the position and posture estimation part 22. The trigger detection part 31 supplies the detection result of the trigger to the video control part 33.

The sensing part 32 senses the three-dimensional positions of real objects in a real space around the HMD 1 on the basis of the depth information acquired from the distance measurement sensor 12, the estimation results of the position and posture, for example, of the HMD 1 supplied from the position and posture estimation part 22, and the video supplied from the image processing part 21. The three-dimensional positions of the real objects are sensed by use of recognition techniques such as semantic segmentation and instance segmentation or AR markers, for example. The sensing part 32 supplies the sensing results of the three-dimensional positions of the real objects to the video control part 33.

The video control part 33 controls the video displayed on the display unit 15 by controlling the CG generation part 34 and the synthesis part 35 on the basis of the result of the trigger detection by the trigger detection part 31 and the results of the sensing by the sensing part 32 of the three-dimensional positions of the real objects.

For example, on the basis of the result of the trigger detection by the trigger detection part 31, the video control part 33 determines a virtual object to be displayed on the display unit 15, and executes gradation processing to make the virtual object gradually appear or gradually shrink or disappear. The virtual object is made to gradually appear or gradually disappear in a manner corresponding to the virtual object itself or the trigger.

Also, for example, the video control part 33 determines the three-dimensional position (generation point) at which the virtual object is to be displayed, on the basis of the result of the sensing by the sensing part 32 of the three-dimensional position of the real object.

The CG generation part 34 generates a CG video of a virtual object to be superimposed on the video of the real space. The CG generation part 34 also generates a CG video of a virtual space. The CG generation part 34 supplies the generated CG video to the synthesis part 35.

The synthesis part 35 generates the video to be displayed on the display unit 15, by combining the video of the real space supplied from the image processing part 21 with the CG video of the virtual object supplied from the CG generation part 106. The synthesis part 35 uses the CG video of the virtual space supplied from the CG generation part 106 as the video to be displayed unmodified on the display unit 15.

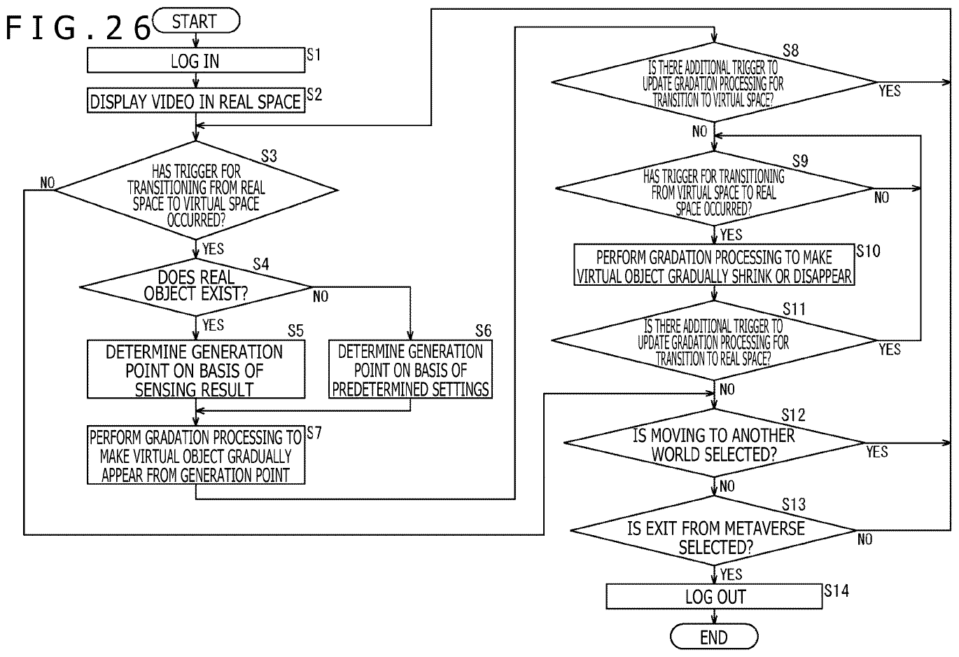

Explained next with reference to the flowchart of FIG. 26 is the processing performed by the HMD 1 configured as discussed above.

In step S1, the HMD 1 logs in to a metaverse. Upon login to the metaverse, content (world) to be experienced by the user, for example, is selected.

In step S2, the display unit 25 displays a video of a real space.

In step S3, the trigger detection part 31 determines whether or not a trigger for transitioning from the video of the real space to a video of a virtual space has occurred. As the trigger for transitioning from the video of the real space to the video of the virtual space on the HMD 1, the user's specific action or state is set beforehand for each piece of content to be provided or for each virtual object to be displayed, for example.

In a case where it is determined in step S3 that the trigger for transitioning from the video of the real space to the video of the virtual space has occurred, processing proceeds to step S4. In step S4, the video control part 33 determines whether or not a real object exists in the real space, on the basis of the results of the sensing by the sensing part 32 of the three-dimensional positions of real objects.

In a case where it is determined in step S4 that a real object exists, processing proceeds to step S5. In step S5, the video control part 33 determines a point at which the virtual object is to be generated, on the basis of the result of the sensing by the sensing part 32 of the three-dimensional position of the real object. In a case where the sensing part 32 can recognize the real object, the video control part 33 can dynamically change the three-dimensional position of the virtual object.

On the other hand, in a case where it is determined in step S4 that a real object does not exist, processing proceeds to step S6. In step S6, the video control part 33 determines the point at which the virtual object is be generated, on the basis of predetermined settings. In a case where the sensing part 32 cannot recognize a real object, the video control part 33 cannot dynamically change the three-dimensional position of the virtual object.

After the generation point of the virtual object is determined in step S5 or in step S6, processing proceeds to step S7. In step S7, the video control part 33 performs gradation processing to make the virtual object gradually appear from the generation point. The gradation processing for making the virtual object gradually appear causes a transition to the video of the virtual space or to the video of an AR space.

In step S8, the HMD 1 determines whether or not there is an additional trigger to update the gradation processing that causes a transition to the virtual space.

In a case where it is determined in step S8 that there is an additional trigger, processing returns to step S3, and the subsequent processing is performed.

On the other hand, in a case where it is determined in step S8 that there is no additional trigger, processing proceeds to step S9. In step S9, the trigger detection part 31 determines whether a trigger for transitioning from the video of the virtual space to the video of the real space has occurred. The HMD 1 waits until a trigger for transitioning from the video of the virtual space to the video of the real space occurs. As the trigger for transitioning from the video of the virtual space to the video of the real space on the HMD 1, the user's specific action or state is set beforehand for each piece of content to be provided or for each virtual object to be displayed, for example.

In a case where it is determined in step S9 that a trigger for transitioning from the video of the virtual space to the video of the real space has occurred, processing proceeds to step S10. In step S10, the video control part 33 performs gradation processing to make the virtual object gradually shrink or disappear. The gradation processing for making the virtual object shrink or disappear causes a transition to the video of the AR space or to the video of the real space.

In step S11, the HMD 1 determines whether or not there is an additional trigger to update the gradation processing that Causes a transition to the real space.

In a case where it is determined in step S11 that there is an additional trigger, processing returns to step S9, and the subsequent processing is performed.

On the other hand, in a case where it is determined in step S11 that there is no additional trigger, processing proceeds to step S12. In step S12, the HMD 1 determines whether or not moving to another world (experiencing another piece of content) has been selected.

In a case where it is determined in step S12 that moving to another world has been selected, processing returns to step S3, and the subsequent processing is performed.

On the other hand, in a case where it is determined in step S12 that moving to another world has not been selected, processing proceeds to step S13. In step S13, the HMD 1 determines whether or not a user has selected exit from the metaverse.

In a case where it is determined in step S13 that exit from the metaverse has not been selected, processing returns to step S3, and the subsequent processing is performed.

On the other hand, in a case where it is determined in step S13 that exit from the metaverse has been selected, processing proceeds to step S14. In step S14, the HMD 1 logs out from the metaverse.

The above processing prevents the user from experiencing a loss of the sense of immersion or feeling a sense of emptiness and thereby allows the content to be presented more advantageously.

### 3. Modifications

The gradation processing may be performed when triggered by a situation of communication between a character in a VR space or a virtual space and a user. The communication situation between the character and the user is included in the user's state.

For example, in a case where a handshake event with an actor's avatar takes place in a VR space or a virtual space, the start of a conversation between the user and the actor is used as a trigger to execute the gradation processing for transitioning to the virtual space. Also, the gradation processing for transitioning to the virtual space or to a real space is carried out in a manner reflecting the level of excitement and duration of the conversation.

For example, in a case where outdoor content is provided, the gradation processing for transitioning to a virtual space is executed in a manner reflecting the intimacy between a user and an animal virtual object in a VR space. For example, when the animal virtual object becomes interested in food or a toy given by the user, it triggers the execution of the gradation processing. The gradation processing is also executed in a manner corresponding to the amount of the food eaten by the animal virtual object or the time spent by the animal virtual object playing with the toy.

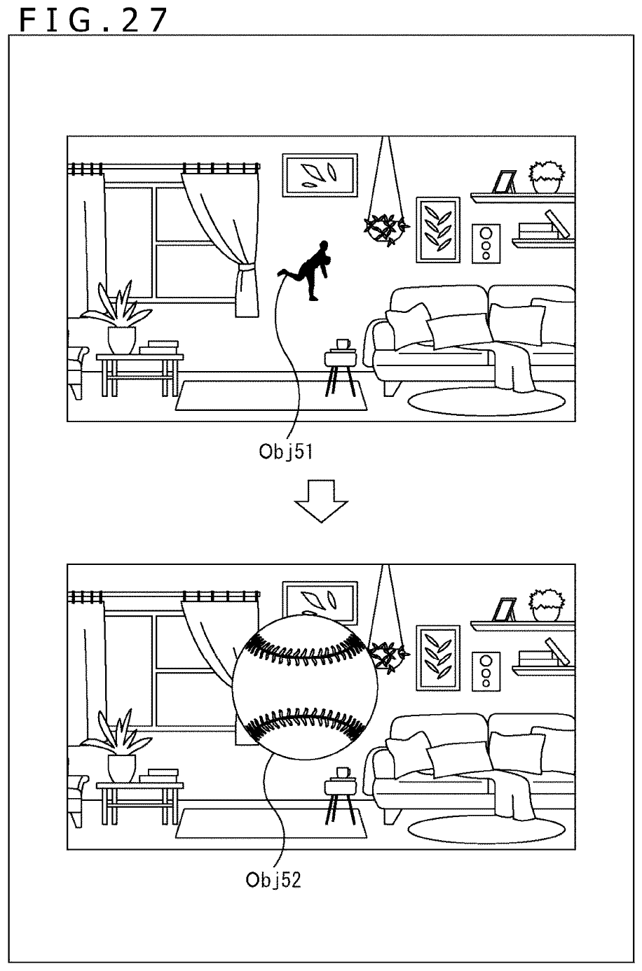

For example, in a case where sports content is provided, a virtual object Obj51 of a pitcher is placed in a VR space as depicted in the upper part of FIG. 27. A virtual object Obj52 of a ball thrown by the pitcher virtual object Obj51 moves toward a user as depicted in the lower part of FIG. 27. When the user catches the virtual object Obj52 of the approaching ball, it triggers a transition from the video of the VR space to the video of a virtual space.

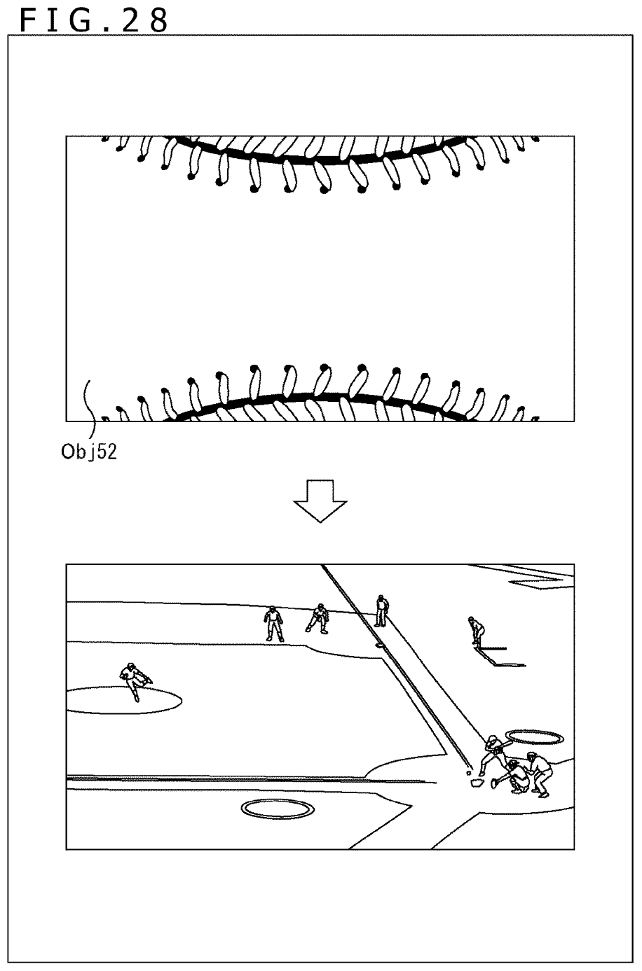

Just before the user catches the ball virtual object Obj52, a portion of the ball virtual object Obj52 is displayed over the entire screen of the display unit 15 as depicted in the upper part of FIG. 28. When the user catches the ball virtual object Obj52, the ball virtual object Obj52 goes out of view, and a virtual-space video representing a ballpark is displayed on the display unit 15 as depicted in the lower part of FIG. 28.

It is to be noted that the transition from the video of the VR space to the video of the virtual space may also be performed in stages according to the distance between the ball virtual object Obj52 and the user. For easier understanding of the transition from the video of the VR space to the video of the virtual space, the speed of the ball virtual object Obj51 may be made lower than the normal speed.

### Example of Computer Configuration

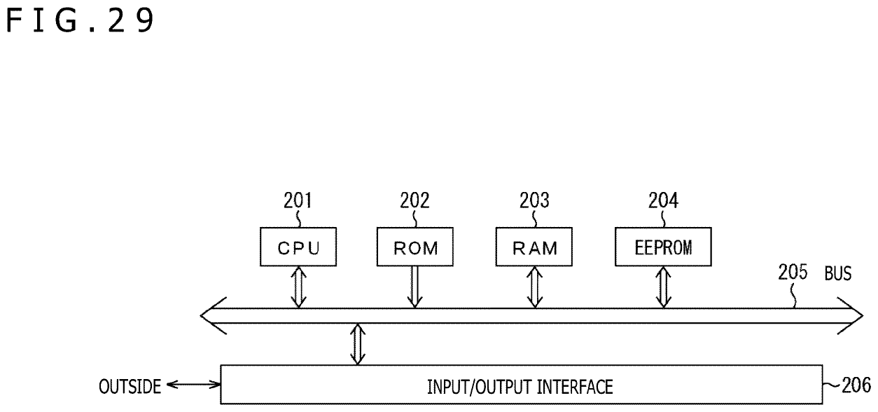

FIG. 29 is a block diagram depicting an example of a hardware configuration of a computer that executes the above-described series of processing using programs.

In the computer, a CPU (Central Processing Unit) 201, a ROM (Read Only Memory) 202, a RAM (Random Access Memory) 203, and an EEPROM (Electronically Erasable and Programmable Read Only Memory) 204 are interconnected by a bus 205. An input/output interface 206 is further connected to the bus 205 and is thereby connected to the outside.

In the computer configured as described above, the CPU 201 loads, for example, programs stored in the ROM 202 and the EEPROM 204 into the RAM 203 via the bus 205 and executes the loaded programs to perform the above-described series of processing. Also, the programs executed by the computer (CPU 201) can be written beforehand to the ROM 202 or can be installed or updated in the EEPROM 204 from the outside via the input/output interface 206.

It is to be noted that the program for execution by the computer may be performed chronologically, i.e., in the sequence explained in this description, in parallel with other programs, or in otherwise appropriately timed fashion such as when the program is invoked as needed.

It is to be noted that the advantageous effects stated in this description are only examples, are not limitative of the present technology, and may provide other advantages as well.

The present technology is not limited to the embodiments discussed above and may be implemented in diverse variations so far as they are within the scope of the present technology.

For example, the present technology may be implemented as a cloud computing setup in which a single function is processed cooperatively by a plurality of apparatuses via a network on a shared basis.

Also, each of the steps discussed in reference to the above-described flowchart may be executed either by a single apparatus or by a plurality of apparatuses on a shared basis.

Further, in a case where a single step includes a plurality of processes, the plurality of processes included in the single step may be executed either by a single apparatus or by a plurality of apparatuses on a shared basis.

### Exemplary Combinations of the Configured Components

The present technology may also be implemented in the following configurations.

(1)

An information processing apparatus including:
a detection part configured to detect a trigger; and
a video control part configured to cause, upon occurrence of the trigger, a virtual object to be displayed on a wearable device displaying a video of a real space corresponding to a field of view of a user.
   (2)

The information processing apparatus according to (1) above, further including:
a sensing part configured to sense a three-dimensional position of a real object in the real space,
in which the video control part determines a three-dimensional position at which the virtual object is to be displayed, on the basis of a result of sensing by the sensing part.
   (3)

The information processing apparatus according to (1) or (2) above,
in which, upon occurrence of the trigger, the video control part causes the video displayed on the wearable device to transition from the video of the real space to a video of a virtual space in which the virtual object is placed.
   (4)

The information processing apparatus according to (3) above,
in which the video control part causes at least one of a plurality of the virtual objects placed in the virtual space to be displayed every time the trigger occurs, thereby causing the video displayed on the wearable device to transition from the video of the real space to the video of the virtual space.
   (5)

The information processing apparatus according to (3) or (4) above,
in which, upon occurrence of the trigger, the video control part causes the video displayed on the wearable device to transition from the video of the virtual space to the video of the real space.
   (6)

The information processing apparatus according to (5) above,
in which, when the video displayed on the wearable device transitions from the video of the virtual space to the video of the real space, the video control part causes at least one of a plurality of the virtual objects placed in the virtual space to be displayed along with the video of the real space.
   (7)

The information processing apparatus according to (5) or (6) above,
in which the video control part makes the virtual object gradually shrink or disappear, thereby causing the video displayed on the wearable device to transition from the video of the virtual space to the video of the real space.
   (8)

The information processing apparatus according to any one of (1) to (7) above,
in which the video control part gradually displays the virtual object.
   (9)

The information processing apparatus according to (8) above,
in which the video control part gradually displays the virtual object by changing a shape of the virtual object.
   (10)

The information processing apparatus according to any one of (1) to (9) above,
in which the video control part displays the virtual object by expanding the real space, by replacing a real object in the real space with the virtual object, or by superimposing the virtual object onto the real object.
   (11)

The information processing apparatus according to any one of (1) to (10) above,
in which the detection part detects an action of the user or a state of the user as the trigger.
   (12)

The information processing apparatus according to (11) above,
in which the state of the user includes a situation of communication between the user and a character displayed on the wearable device.
   (13)

The information processing apparatus according to any one of (1) to (12) above,
in which, upon occurrence of the trigger set beforehand for each virtual object, the video control part causes the virtual object to be displayed.
   (14)

The information processing apparatus according to any one of (1) to (13) above,
in which the wearable device includes an HMD.
   (15)

An information processing method including:
by an information processing apparatus,
detecting a trigger; and
upon occurrence of the trigger, causing a virtual object to be displayed on a wearable device displaying a video of a real space corresponding to a field of view of a user.
   (16)

A program for causing a computer to execute processing of:
detecting a trigger; and
upon occurrence of the trigger, causing a virtual object to be displayed on a wearable device displaying a video of a real space corresponding to a field of view of a user.

### REFERENCE SIGNS LIST

1: HMD
23: Information processing part
31: Trigger detection part
32: Sensing part
33: Video control part
34: CG generation part
35: Synthesis part

1. An information processing apparatus comprising:
a detection part configured to detect a trigger; and
a video control part configured to cause, upon occurrence of the trigger, a virtual object to be displayed on a wearable device displaying a video of a real space corresponding to a field of view of a user.

2. The information processing apparatus according to claim 1, further comprising:
a sensing part configured to sense a three-dimensional position of a real object in the real space,
wherein the video control part determines a three-dimensional position at which the virtual object is to be displayed, on a basis of a result of sensing by the sensing part.

3. The information processing apparatus according to claim 1,
wherein, upon occurrence of the trigger, the video control part causes the video displayed on the wearable device to transition from the video of the real space to a video of a virtual space in which the virtual object is placed.

4. The information processing apparatus according to claim 3,
wherein the video control part causes at least one of a plurality of the virtual objects placed in the virtual space to be displayed every time the trigger occurs, thereby causing the video displayed on the wearable device to transition from the video of the real space to the video of the virtual space.

5. The information processing apparatus according to claim 3,
wherein, upon occurrence of the trigger, the video control part causes the video displayed on the wearable device to transition from the video of the virtual space to the video of the real space.

6. The information processing apparatus according to claim 5,
wherein, when the video displayed on the wearable device transitions from the video of the virtual space to the video of the real space, the video control part causes at least one of a plurality of the virtual objects placed in the virtual space to be displayed along with the video of the real space.

7. The information processing apparatus according to claim 5,
wherein the video control part makes the virtual object gradually shrink or disappear, thereby causing the video displayed on the wearable device to transition from the video of the virtual space to the video of the real space.

8. The information processing apparatus according to claim 1,
wherein the video control part gradually displays the virtual object.

9. The information processing apparatus according to claim 8,
wherein the video control part gradually displays the virtual object by changing a shape of the virtual object.

10. The information processing apparatus according to claim 1,
wherein the video control part displays the virtual object by expanding the real space, by replacing a real object in the real space with the virtual object, or by superimposing the virtual object onto the real object.

11. The information processing apparatus according to claim 1,
wherein the detection part detects an action of the user or a state of the user as the trigger.

12. The information processing apparatus according to claim 11,
wherein the state of the user includes a situation of communication between the user and a character displayed on the wearable device.

13. The information processing apparatus according to claim 1,
wherein, upon occurrence of the trigger set beforehand for each virtual object, the video control part causes the virtual object to be displayed.

14. The information processing apparatus according to claim 1,
wherein the wearable device includes an HMD.

15. An information processing method comprising:
by an information processing apparatus,
detecting a trigger; and
upon occurrence of the trigger, causing a virtual object to be displayed on a wearable device displaying a video of a real space corresponding to a field of view of a user.

16. A program for causing a computer to execute processing of:
detecting a trigger; and
upon occurrence of the trigger, causing a virtual object to be displayed on a wearable device displaying a video of a real space corresponding to a field of view of a user.
